(19) United States
(12) Patent Application Publication
(10) Pub. No.: US 2003/0080917 A1
(43) Pub. Date: May 1, 2003

(54) Dielectric shielding for improved RF performance of RFID

(76) Inventors: Matthew Thomas Adams, Cincinnati, OH (US); Douglas A. Taylor, Monroe, OH (US)

Correspondence Address: ORUM & ROTH, 53 W. JACKSON BLVD., CHICAGO, IL, 60604, US

(21) Appl. No.: 10/194,144

(22) Filed: Jul. 12, 2002

Related U.S. Application Data
(60) Provisional application No. 60/305,040, filed on Jul. 12, 2001.

(51) Int. Cl. H01Q 1/52

(52) U.S. Cl. 343/841; 343/700 MS

(57) ABSTRACT

The RFID label or tag with dielectric shielding to insulate the RFID integrated circuit and antenna from the target surface which the device may be in contact. Dielectric shielding may be formed from the liner, cut so that when the liner is peeled off the section between the transponder and the target surface remains. The liner may be arranged so that the portion covering the RFID transponder cannot be removed accidentally through use of a zone not coated with release agent.

Dielectric shielding may be formed from a portion of the face sheet. The face sheet will be configured to allow it to be folded upon itself to provide insulation between the RFID transponder and the target surface. Adhesive applied to the face sheet may be used to create an adhesive surface for attaching a RFID label to a target surface.

This application claims the benefit of provisional application 60/305,040 filed Jul. 12, 2001.

### FIELD OF THE INVENTION

This invention relates to RFID's and more particularly to an RFID label or tag with dielectric shielding to prevent read range degradation when in contact with or adhered to a substrate.

### DESCRIPTION OF RELATED ART

RFID's may be integrated into RFID devices, such as labels and/or tags. Typically, RFID devices comprise a layered structure of various media and adhesive containing an antenna and integrated circuit. Common RFID devices include labels and tags. A RFID label has exposed adhesive for attaching the label to a target surface, while a RFID tag does not have exposed adhesive.

When the RFID device is attached to or in contact with a target surface the performance of the RFID transponder is affected. Electrical interference caused by the objects which the RFID antenna and/or integrated circuit are in contact with decrease the read range of the RFID. The interference effect increases as the operating frequency of the RFID increases. For example, the 13.56 MHz transponder is less effected by interference than the 2.4 GHz transponder.

Previously, the decreased read range resulting when an RFID contacts or is applied to a target surface was accepted. Alternatively, the transponder antenna design was modified to tune it for a particular label or device/surface combination. Preparing a tuned antenna for such a combination requires a significant amount of design and testing. Preparing a series of tuned antennas, modified for each projected surface combination is not economical as the number of device/surface combinations is infinite. Further, in the case of a RFID tag, it may not be possible to anticipate which surfaces the tag will contact.

An object of this invention is to provide a cost-effective alternative to either decreased read range or retuning of transponders as a result of electrical interference from the different target surfaces.

### SUMMARY OF THE INVENTION

A RFID label or tag with dielectric shielding to isolate the RFID integrated circuit and antenna from the target surface which the device is in contact with. Dielectric shielding may be formed from the liner, cut so that when the liner is peeled off a section between the RFID circuit and/or antenna and the target surface remains. The liner material may be arranged so that it cannot be removed accidentally from the device through the use of a zone not coated with a release agent that prevents easy separation of the adhesive from the liner material.

In another embodiment, a portion of the device face sheet can be used as a shielding agent. The face sheet may be configured to allow it to be folded upon itself to provide an isolation layer between the RFID transponder and the target surface. Adhesive patterns applied to the face sheet may be used to create an adhesive surface for attaching the RFID label to a target surface once it has been folded to isolate the transponder from the target surface.

### BRIEF DESCRIPTION OF THE DRAWINGS

FIG. 1 is a schematic diagram of a pressure sensitive label according to the present invention.

FIG. 2 is a schematic diagram of a label according to FIG. 1 with additional adhesive.

FIG. 3a is a schematic diagram of an RFID label using a portion of the face sheet as a shielding agent.

FIG. 3b is a schematic diagram of an RFID label using a portion of the face sheet as a shielding agent.

### DETAILED DESCRIPTION

A RFID antenna and circuit suffers a read range decrease when it is inserted into a label or tag construction. A RFID device, such as a label or tag, in contact with foreign objects, i.e. a target surface, will have varying transponder impedance. Each target surface has a different dielectric constant which affects the overall impedance of the transponder resulting in further decreases in read range. Through application of dielectric shielding, the reduction in read range may be minimized. Dielectric shielding of the RFID antenna and/or integrated circuit may be accomplished by surrounding the RFID circuit and/or antenna with a dielectric material thereby insulating the circuit from contact with any conductive surfaces.

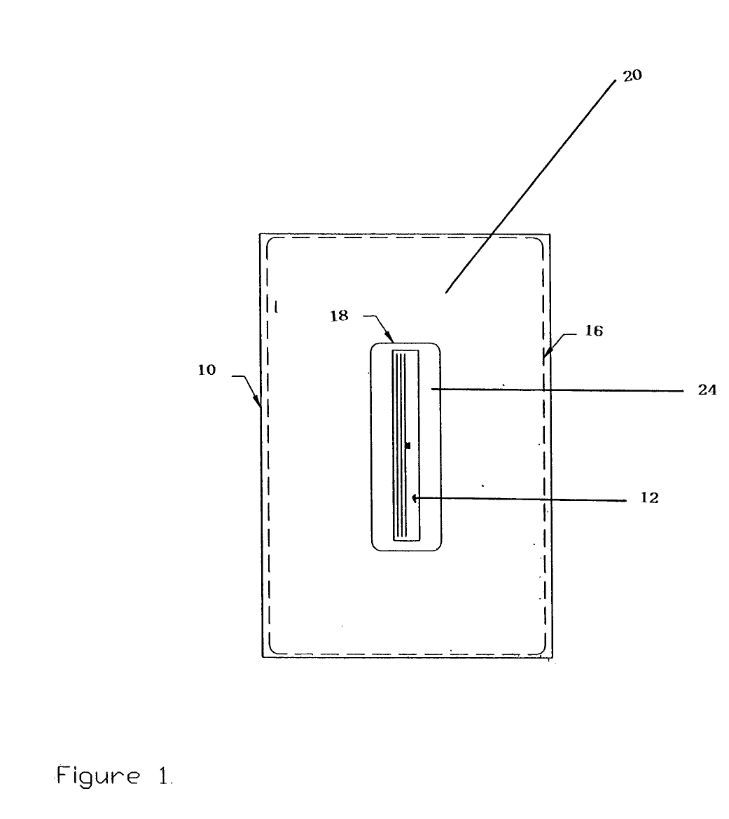

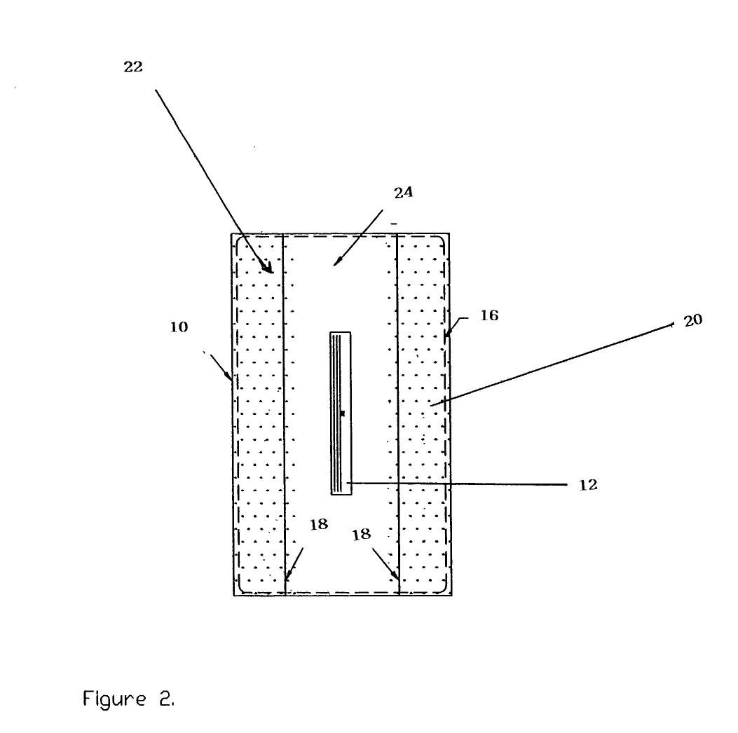

Referring to FIGS. 1 and 2, pressure sensitive RFID label 10 is shown. Upper surface of label 10 is face sheet (not shown). The layers of label 10 have a label cut 16 which defines label 10 and allows it to be removed from liner 20. The lower surface of RFID label 10 is covered with liner 20 which when removed exposes pressure sensitive adhesive (not shown) which allows label 10 to be attached to target surface (not shown).

In one embodiment a liner 20 may be used as the shielding agent. Cut 18 made in liner 20 allowing liner 20 to be peeled away leaving a portion of liner 20, the shielding zone 24, attached to label 10. Adhesive (not shown) for applying label 10 to target surface (not shown) is exposed in areas where liner 16 is removed.

When liner 20 is separated from label 10, shielding zone 24 of liner 20 remains with label 10. Shielding zone 24 acts as an insulator between the target surface (not shown) and the RFID transponder 12. Accordingly, when label 10 is applied to target surface (not shown) transponder 12 is insulated from surface. Liner 20 material may be any material which serves as a carrier for the label 10, providing easier release of label 10, as well as acting as an insulator. The insulating value of liner 20 may be balanced with its suitability as a carrier having an easy release characteristic.

Using the FIG. 1 embodiment, it is possible that the shielding zone 24 of the liner 20 may be accidentally removed thereby reducing the read range transponder 12. To minimize the chances of this occurring, liner 20 may be constructed with an omitted release agent zone substantially corresponding to the shielding zone 24, preventing easy separation of adhesive (not shown) from the liner 20 material as shown in FIG. 2. By omitting the release agent 22 from the shielding zone 24, as the liner 20 is removed the liner 20 separates easily from the label 10 except for the shielding zone 24 which lacks release agent and which is fully adhered by the adhesive to the liner 20.

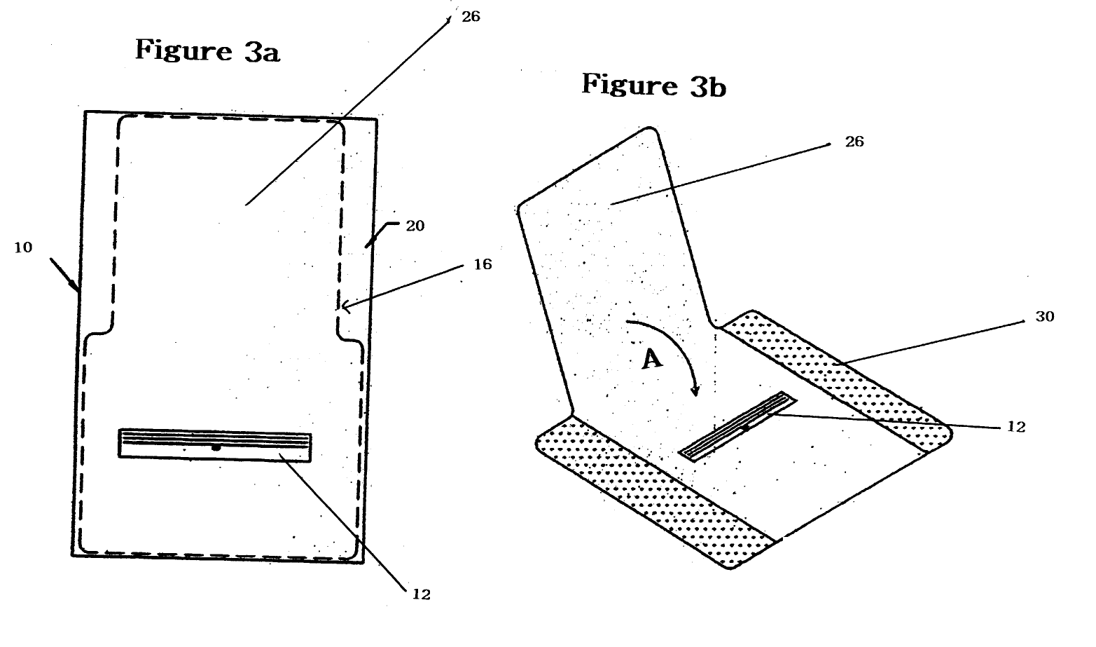

In a further embodiment, the label face sheet 26 may be utilized as a shielding agent. As shown in FIGS. 3a and 3b, a face sheet 26 may be cut in a manner allowing sheet 26 to be, folded onto itself encapsulating the transponder 12. Label 10 is circumscribed by a label cut 16 such that when the label 10 is removed from liner 20, it is defined by label cut 16. In bottom portion of label 10 is transponder 12. When label 10 is removed from liner 20, top portion of label 10 without transponder 12 can be folded in the direction shown by arrow A to cover bottom portion with transponder 12.

Adhesive 30 should be sufficient to attach the label 10 to the target surface (not shown) as well as provide a binding means for maintaining the top portion of a label upon the bottom portion of the label. Where the transponder 12 is otherwise attached to the face sheet 26, adhesive 30 coating on the face sheet 26 for this portion is not required.

A variation of this embodiment is shown in FIG. 3b. Where the folding portions of the face sheet are well defined, adhesive 30 may be applied only to that portion of the face sheet 26 where contact with the target surface (not shown) is planned.

The present invention is entitled to a range of equivalents and is to be limited only by the following claims:

We claim:

1. An RFID device comprising:
a layered construction of
a first layer comprising a face sheet;
a second layer comprising a transponder carrier; and
a transponder,
wherein said transponder is insulated from a surface by a shielding means.

2. The RFID device of claim 1, wherein said RFID device has a removable liner and said shielding means is a shielding portion of said liner.

3. The RFID device of claim 2, wherein a removable portion of said liner is coated with release agent.

4. The RFID device of claim 2, wherein said shielding portion is free of release agent.

5. The RFID device of claim 1, wherein said shielding means is a shielding portion of said face sheet.

6. The RFID device of claim 5, wherein said shielding portion folds upon a transponder carrying portion of said face sheet encapsulating said transponder.

7. The RFID device claim 6, wherein said face sheet has adhesive where said face sheet folds over itself.

8. The RFID device of claim 5, wherein said RFID device is a label and adhesive is exposed on portion of said face sheet that attaches to said surface.

9. The RFID device of claim 5, wherein said RFID device is a tag.
